(19) United States
(12) Patent Application Publication
(10) Pub. No.: US 2025/0079052 A1
(43) Pub. Date: Mar. 6, 2025

(54) High Reliability Variable Resistor Device

(71) Applicant: Brenden J. Wang, Irvine, CA (US)

(72) Inventor: Brenden J. Wang, Irvine, CA (US)

(21) Appl. No.: 18/424,391

(22) Filed: Jan. 26, 2024

Related U.S. Application Data
(60) Provisional application No. 63/536,152, filed on Sep. 1, 2023.

(51) Int. Cl. H01C 10/46

(52) U.S. Cl. CPC H01C 10/46

(57) ABSTRACT

A high reliability variable resistor device for extending the lifetime of the potentiometer includes a substrate that is electrically insulative. The substrate is installed within a control circuit having a control switch. A wiper movably coupled to the substrate is electrically conductive. A resistive material and a conductive common trace are coupled to the substrate. An array of taps electrically coupled to the resistive material extends perpendicularly outward toward the common trace. The wiper contacts at least one of the array of taps while being spaced from the resistive material. The wiper moves across the array of taps and the common trace when the wiper moves along the substrate in response to actuation of the control switch. The spacing of the array of taps along the resistive material forms a series of resistive changes that adjusts a setting of the control circuit.

### CROSS-REFERENCE TO RELATED APPLICATIONS

I hereby claim the benefit under 35 U.S.C. Section 119 (e) to Provisional Application No. 63/536,152, filed Sep. 1, 2023.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to potentiometers and more particularly pertains to a new potentiometer for extending the lifetime of the potentiometer.

### (2) Description of Related Art Including Information Disclosed Under 37 CFR 1.97 and 1.98

The prior art relates to potentiometers. Potentiometers are used to measure voltages for control circuits in myriad electrical devices. The voltages may be measured to determine a setting of a particular control circuit. For example, audio equipment may use a potentiometer in a volume control switch, or a power drill may use a potentiometer in a trigger to control a rotational speed of the drill bit. An electric instrument may have a potentiometer within a pedal to control the tone or volume of the instrument. Potentiometers measure voltages by moving an electrically conductive wiper along a substrate in response to actuation of the control switch. In the examples above, the control switch would be the trigger or the pedal. The control switch moves the wiper across different elements mounted on the substrate. Some of those elements are electrically conductive, while others are electrically resistive. The resistive changes as the wiper moves across the substrate correspond to adjustments in the electrical circuit within which the potentiometer is installed. In the electric drill example, the resistive changes may correspond to an incremental change in the speed of the drill bit. In the electric instrument example, the resistive changes may correspond to incremental changes in the tone or volume of the instrument. In prior art potentiometers, the wiper physically contacts the electrically resistive material mounted on the substrate. Because this electrically resistive material is often a paste, movement of the wiper across the electrically resistive material can cause degradation. The rate of this degradation correlates with the lifetime of the potentiometer. In other words, the number of times the wiper can slide over the electrically resistive material corresponds to the number of times the control switch can functionally control the speed, tone, volume, or other aspect of the control circuit. Thus, there is a need in the art for a potentiometer device that can minimize or eliminate the physical contact of the wiper across the electrically resistive material thereby extending the lifetime of the potentiometer device.

### BRIEF SUMMARY OF THE INVENTION

An embodiment of the disclosure meets the needs presented above by generally comprising a substrate that is electrically insulative. The substrate is configured for installation within a control circuit having a control switch. A wiper is movably coupled to the substrate. The wiper is electrically conductive. The wiper is configured to be operably coupled to the control switch wherein the wiper is configured to move along the substrate in response to the control switch of the control circuit being actuated. A resistive material is coupled to the substrate. A common trace is coupled to the substrate. The wiper contacts the common trace and moves along the common trace when the wiper moves along the substrate. The common trace is electrically conductive. An array of taps is coupled to the substrate. The array of taps is electrically conductive. The array of taps is electrically coupled to the resistive material. The array of taps physically contacts and extends perpendicularly outward from the resistive material toward the common trace. The wiper contacts at least one of the array of taps while being spaced from the resistive material. The wiper moves across the array of taps when the wiper moves along the substrate. Each tap of the array of taps is spaced from the others along a length of the resistive material. The array of taps forms a series of resistive changes whereby a change of resistance from one tap of the array of taps to an adjacent tap of the array of taps comprises a known increment of the series of resistive changes. The series of resistive changes is configured to adjust a setting of the control circuit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a high reliability variable resistor device according to an embodiment of the disclosure.

FIG. 2 is a side view of an embodiment of the disclosure.

FIG. 3 is a top view of an embodiment of the disclosure.

FIG. 4 is a front view of an embodiment of the disclosure.

FIG. 5 is a back view of an embodiment of the disclosure.

FIG. 6 is an in-use view of an embodiment of the disclosure.

FIG. 7 is a top view of an embodiment of the disclosure.

FIG. 8 is a top view of an embodiment of the disclosure.

FIG. 9 is an in-use view of an embodiment of the disclosure.

FIG. 10 is an isometric exploded view of an embodiment of the disclosure.

FIG. 11 is an isometric view of an embodiment of the disclosure.

FIG. 12 is a side view of an embodiment of the disclosure.

FIG. 13 is an isometric view of an embodiment of the disclosure.

FIG. 14 is an isometric exploded view of an embodiment of the disclosure.

### DETAILED DESCRIPTION OF THE INVENTION

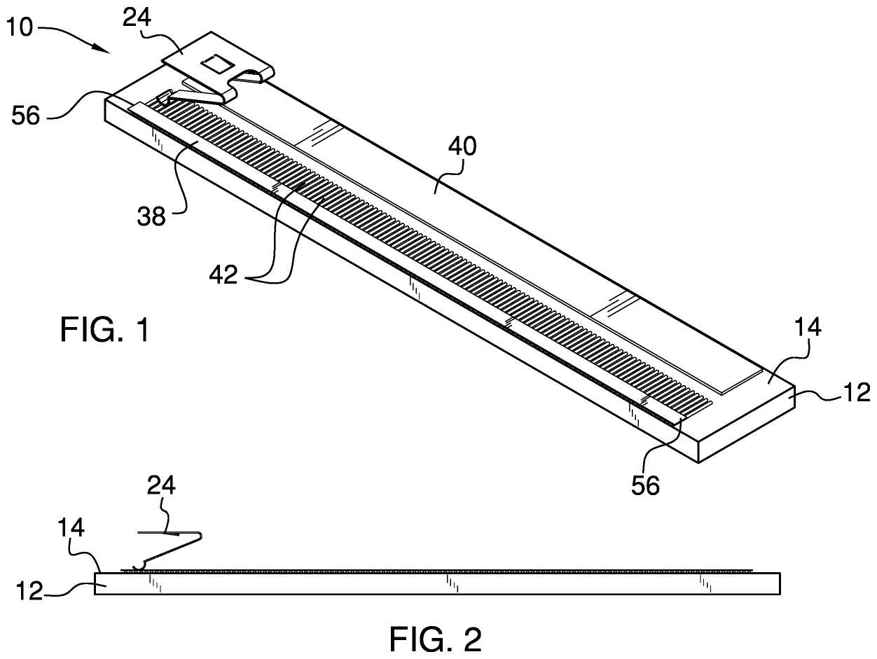

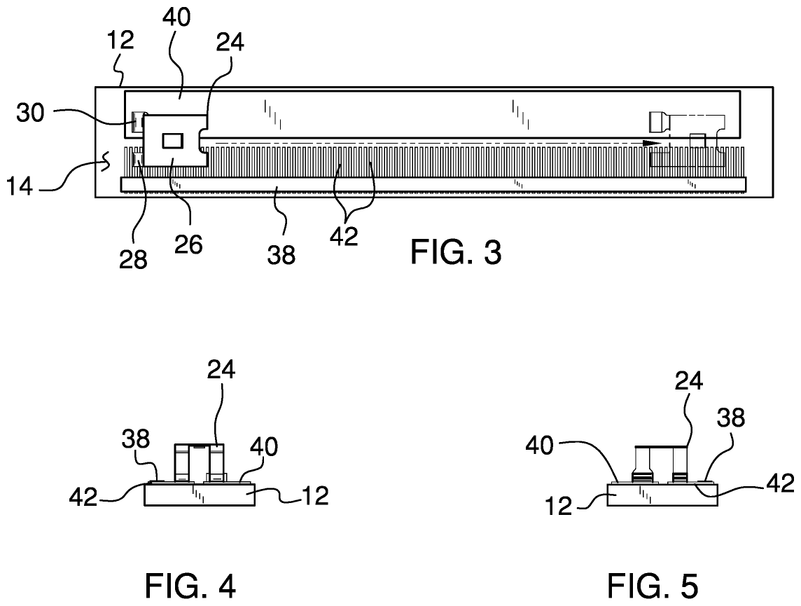

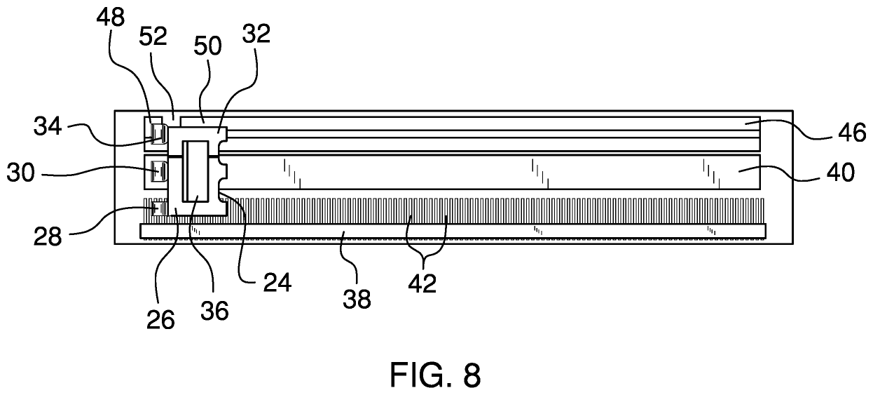

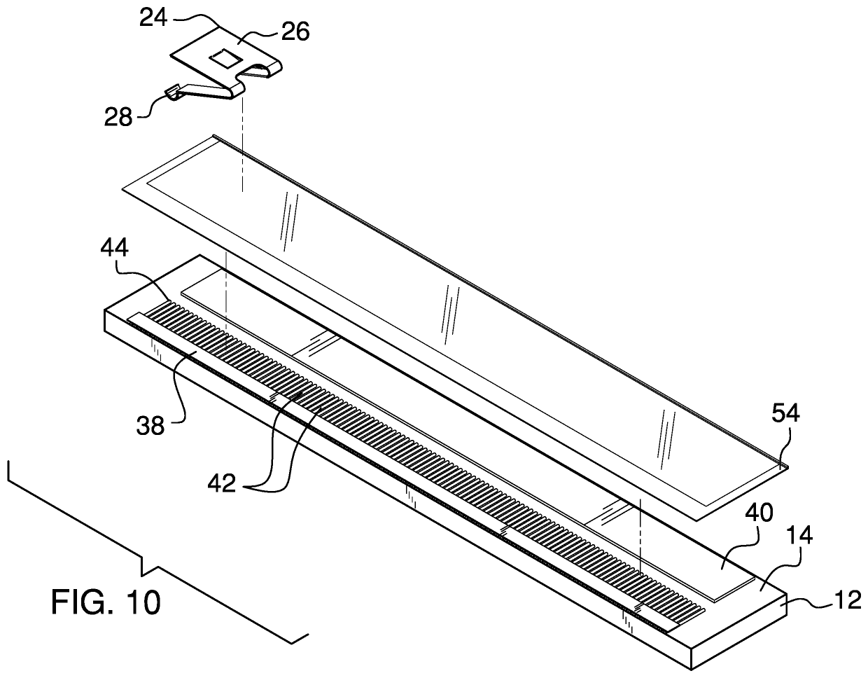

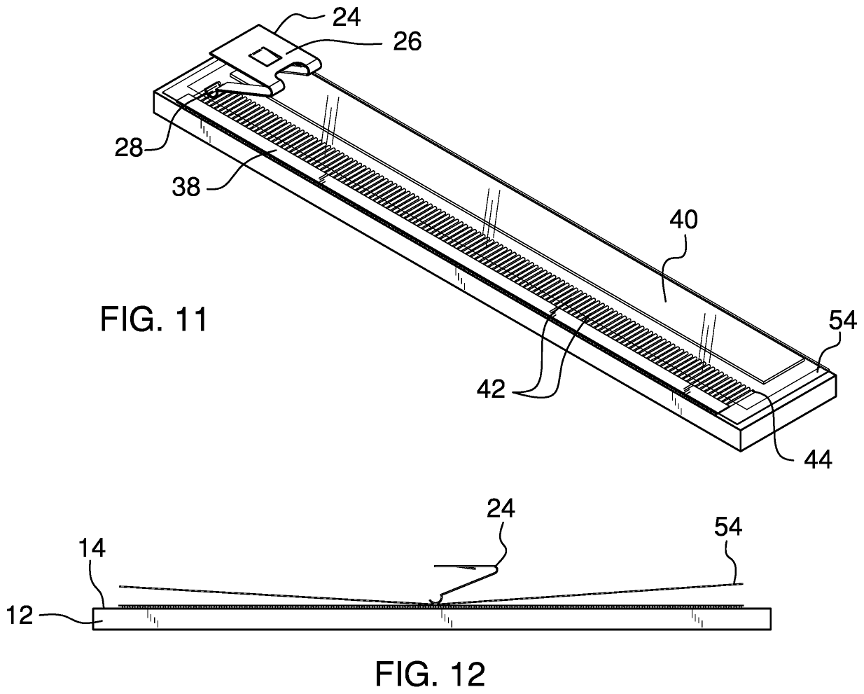

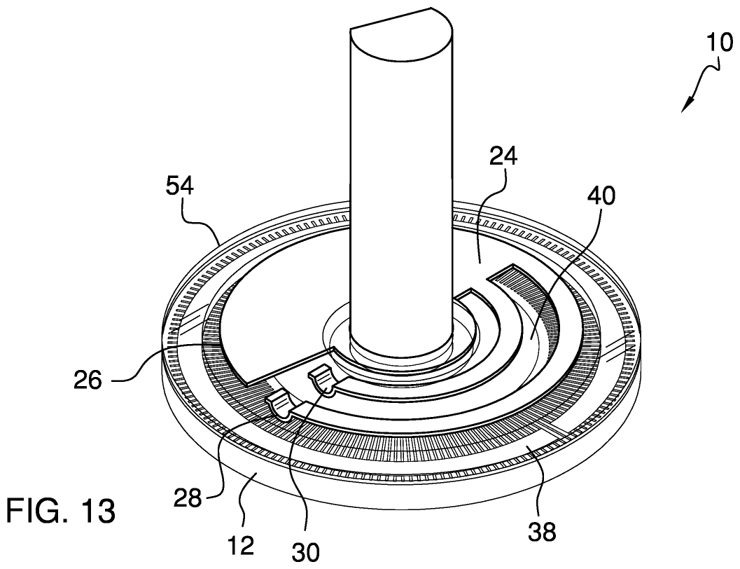

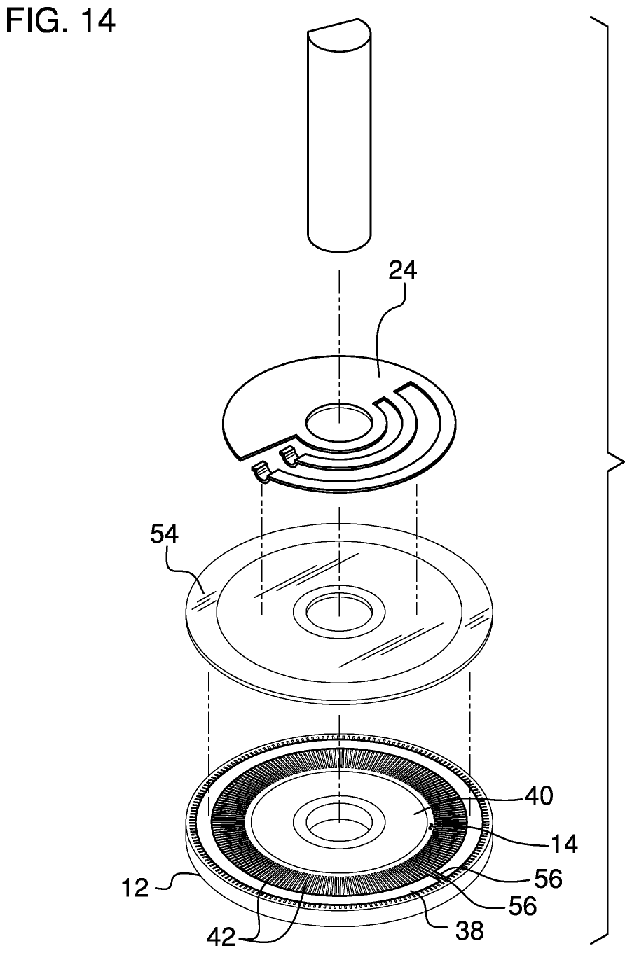

With reference now to the drawings, and in particular to FIGS. 1 through 14 thereof, a new potentiometer embodying the principles and concepts of an embodiment of the disclosure and generally designated by the reference numeral 10 will be described.

As best illustrated in FIGS. 1 through 14, the high reliability variable resistor device 10 generally comprises a substrate 12 having a top surface 14. The top surface 14, or the entire substrate 12, is electrically insulative. For example, the substrate 12 may be a printed circuit board comprising electrically insulative material such as resin, polycarbonate, or glass fibers. Electrically insulative materials are materials that resist the flow of electric current. In other words, electrically insulative materials have high electrical resistivity, meaning that electrically insulative materials can prevent electric current from flowing through the electrically insulative material. Electrons have difficulty moving freely, easily, or quickly through electrically insulative materials.

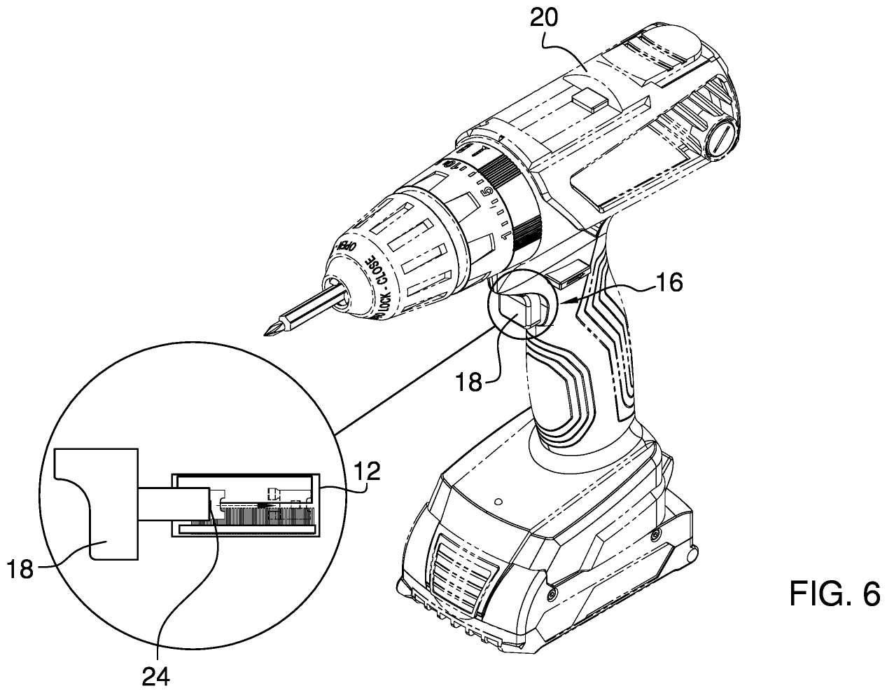

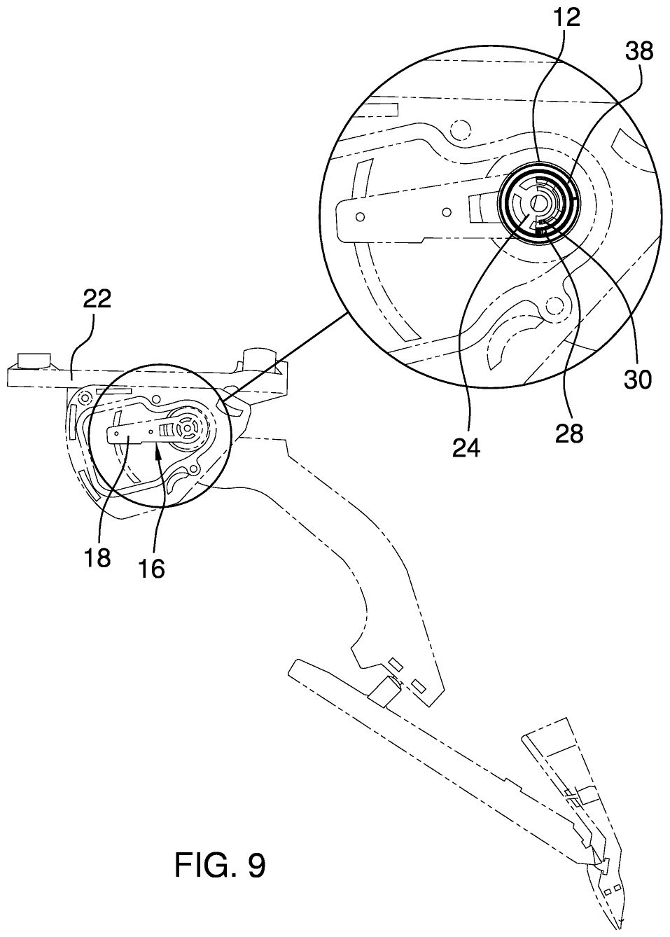

The substrate 12 is configured for installation within a control circuit 16 that has a control switch 18. For example, the control circuit 16 may be used to control a particular setting of a power tool, electrical instrument, radio, or other device. The control switch 16 may accordingly comprise a trigger, pedal, knob, or other appropriate control switch. In the example embodiment shown in FIG. 6, the control circuit 16 is used to control the rotational speed of an electric drill 20, and the control switch 18 is the trigger. In the example embodiment shown in FIG. 9, the control switch 18 is installed in a pedal 22, for example as used with an electric instrument to control the tone or volume of the electric instrument. The high reliability variable resistor device 10 may also be installed or integrated into other control circuits 16 having a control switch 18.

A wiper 24 is movably coupled to the top surface 14 of the substrate 12. The wiper 24 is configured to be operably coupled to the control switch 18 wherein the wiper 24 is configured to move along the top surface 14 of the substrate 12 in response to actuation of the control switch 18 of the control circuit 16.

Embodiments of the wiper 24 may comprise a primary wiper body 26 that is electrically conductive. Electrically conductive materials are able to conduct the flow of electric current. Electrons move easily through electrically conductive materials. Examples of electrically conductive materials appropriate for embodiments of the wiper include copper, gold, aluminum, and other similar metals. Other electrically conductive materials may also be used. A first leg member 28 is coupled to and extends downwardly from the primary wiper body 26. The first leg member 28 is electrically conductive. A second leg member 30 is coupled to and extends downwardly from the primary wiper body 26. The second leg member 30 is electrically conductive.

Some embodiments of the wiper 24 may also include a secondary wiper body 32 that is electrically isolated from the primary wiper body 26. The secondary wiper body 32 is electrically conductive. A third leg member 34 may be coupled to and extend downwardly from the secondary wiper body 32. The third leg member 34 is electrically conductive. A coupler 36 physically attaches the primary wiper body 26 to the secondary wiper body 32 such that the primary wiper body 26 and the secondary wiper body 32 move together along the top surface 14 of the substrate 12. The coupler 36 comprises an electrically insulative material whereby the third leg member 34 remains electrically isolated from the first leg member 28 and the second leg member 30 when the primary wiper body 26 is attached to the secondary wiper body 32.

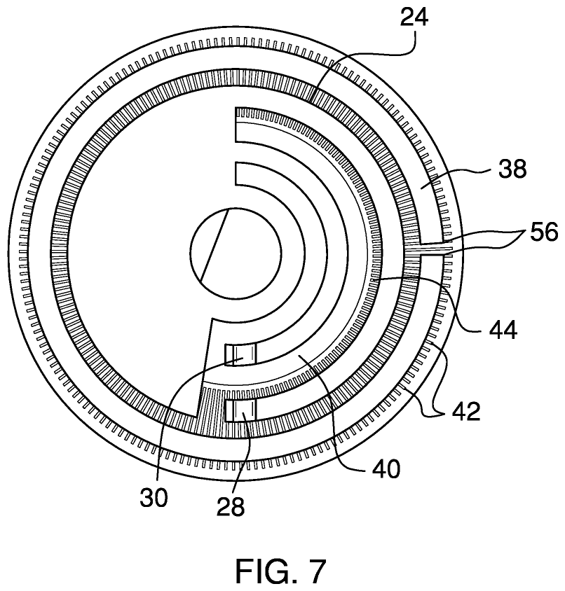

A resistive material 38 is coupled to the top surface 14 of the substrate 12. The resistive material 38 is electrically resistive. For example, the resistive material 38 may comprise a resistive paste including electrically resistive materials such as graphite, resistance wire, carbon particles in plastic, or ceramic and metal mixtures. Like the electrically insulative materials of the substrate, electrically resistive materials generally inhibit or resist the flow of electric current. The resistive material 38 may have a pair of ends 56 that are spaced from each other. For example, as shown in FIG. 1, the pair of ends 56 of the resistive material 38 may be proximate to opposing edges of the substrate 12. In the example shown in FIG. 7, the pair of opposing ends 56 of the resistive material 38 are positioned adjacent to each other on the substrate 12, but are spaced from each other such that there is a space between each end of the pair of ends 56 of the resistive material 38.

A common trace 40 is coupled to the top surface 14 of the substrate 12. The common trace 40 is spaced from the resistive material 38. The wiper 24 contacts the common trace 40. For example, the second leg member 30 of the wiper 24 may contact the common trace 40. The second leg member 30 of the wiper 24 moves along the common trace 40 when the wiper 24 moves along the substrate 12. The common trace 40 is electrically conductive. For example, the common trace 40 may be formed of copper, which is a relatively low-cost conductive material commonly used in potentiometers and printed circuit boards.

An array of taps 42 is coupled to the top surface 14 of the substrate 12. The array of taps 42 is electrically conductive. The array of taps 42 is electrically coupled to the resistive material 38. More specifically, the array of taps 42 may physically contact and extends perpendicularly outward from the resistive material 38 toward the common trace 40. The first leg member 28 of the wiper 24 may contact, or be positioned over, at least one of the array of taps 42 while being spaced from the resistive material 38. For example, each of the array of taps 42 may have a length exceeding a width of the resistive material 38 whereby the first leg member 28 of the wiper 24 is spaced from the resistive material 38 while the first leg member 28 is positioned on the at least one of the array of taps 42. The first leg member 28 of the wiper 24 moves across the array of taps 42 when the wiper 24 moves along the substrate 12. A terminal end 44 of each of the array of taps 42 is spaced from the common trace 40 such that the array of taps 42 is electrically isolated from the common trace 40 except for the at least one of the array of taps 42 that the wiper 24 contacts.

Each of the array of taps 42 is spaced from the others along a length of the resistive material 38 wherein the array of taps 42 forms a series of resistive changes. A change of resistance from one tap of the array of taps 42 to an adjacent tap of the array of taps 42 comprises a known increment of the series of resistive changes. The series of resistive changes is configured to adjust a setting of the control circuit 16. For example, the known increment of the series of resistive changes may correspond to a particular adjustment in rotational speed of the electric drill 20 shown in FIG. 6. When the pedal 22 shown in FIG. 9 is used to adjust a tone of an electric instrument, the known increment in the series of resistive changes may correspond to a particular adjustment in the tone of the electric instrument.

The known increment of the series of resistive changes is linear when the array of taps 42 are spaced equidistantly from each other along the length of the resistive material 38. The known increment of the series of resistive changes is non-linear when the array of taps 42 are spaced at variable distances from each other along the length of the resistive material 38.

A power trace 46 may be coupled to the top surface 14 of the substrate 12. The power trace 42 may be spaced from the resistive material 38. For example, the common trace 40 may be positioned between the power trace 46 and the resistive material 38. The power trace 46 is electrically conductive and is configured to indicate a power state of the control circuit 16 to the system in which the control circuit is installed. The third leg member 34 of the wiper 24 may contact and move along the power trace 46 when the wiper 24 moves along the substrate 12.

Embodiments of the power trace 46 may further comprise an off-state member 48 that is configured to indicate an off-power state of the control circuit 16 when the third leg member 34 of the wiper 24 contacts the off-state member 48. The off-state member 48 may comprise copper or another electrically conductive material.

An on-state member 50 may be spaced from the off-state member 48. The on-state member 50 is configured to indicate an on-power state of the control circuit 16 when the third leg member 34 of the wiper 24 contacts the on-state member 50. The on-state member 50 may have a length that is the same as a length of the top surface 14 of the substrate 12 over which the array of taps 42 is positioned. The on-state member 50 may comprise copper or another electrically conductive material.

The power trace 46 may further comprise a gap 52 that is positioned between the off-state member 48 and the on-state member 50. For example, the wiper 24 may contact the top surface 14 of the substrate 12 when the third leg member 34 is positioned on the gap 52. The gap 52 is generally configured to indicate a neutral power state of the control circuit 16 when the third leg member 34 is positioned on the gap 52.

A flexible material 54 may cover the common trace 40 and the array of copper taps 42. Because the array of copper taps 42 may extend into the resistive material 38, the flexible material 54 may only partially cover the array of copper taps 42 so that the flexible material 54 does not cover the resistive material 38. Alternatively, the flexible material 54 may cover the resistive material 38. In embodiments including the power trace 46, the flexible material 54 may also cover the power trace 46. The flexible material 54 is generally positioned between the wiper 24 and the top surface 14 of the substrate 12. The flexible material 54 is configured to inhibit contaminants from contacting the common trace 40, the array of copper taps 42, and the power trace 46. The flexible material 54 is electrically conductive. The wiper 24 exerts a pressure downwardly on the flexible material 54 as the wiper 24 moves along the top surface 14 of the substrate 12 whereby the flexible material 54 bends inwardly and contacts the common trace 40, at least one of the array of taps 42, and the power trace 46 to electrically connect the common trace 40 to the array of taps 42 and the power trace 46. An example is provided in FIG. 12.

The substrate 12 may have a rectangular shape whereby the wiper 24 has a linear motion across the top surface 14 of the substrate 12. Examples of such embodiments are provided in FIGS. 1-6, 8, and 10-12. The substrate 12 may have a circular shape whereby the wiper 24 has a rotational motion across the top surface 14 of the substrate 12. Examples of such embodiments are provided in FIGS. 7, 9, 13, and 14. The substrate 12 may have an arc shape whereby the wiper 24 has a non-linear motion across the top surface 14 of the substrate 12.

In use, the control switch 18 actuates movement of the wiper 24 across the substrate 12. The wiper 24 contacts the common trace 40 and at least one of the array of taps 42 to measure the voltage differential between the common trace 40 and the array of taps 42. The voltage differential will change by the known increment as the wiper 42 moves across the array of copper taps 42. Because the wiper 24 does not physically contact the resistive material 38, the resistive material 38 does not degrade as quickly as resistive pastes and materials in prior art potentiometers, drastically extending the lifetime of the potentiometer.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A potentiometer assembly comprising:
a substrate being electrically insulative, the substrate being configured for installation within a control circuit having a control switch;
a wiper being movably coupled to the substrate, the wiper being electrically conductive, the wiper being configured to be operably coupled to the control switch wherein the wiper is configured to move along the substrate in response to the control switch of the control circuit being actuated;
a resistive material being coupled to the substrate;
a common trace being coupled to the substrate, the wiper contacting the common trace, the wiper moving along the common trace when the wiper moves along the substrate, the common trace being electrically conductive; and
an array of taps being coupled to the substrate, the array of taps being electrically conductive, the array of taps being electrically coupled to the resistive material, the array of taps physically contacting and extending perpendicularly outward from the resistive material toward the common trace wherein the wiper contacts at least one of the array of taps while being spaced from the resistive material and wherein the wiper moves across the array of taps when the wiper moves along the substrate, the wiper contacting at least one of the array of taps, the array of taps being spaced from each other along a length of the resistive material wherein the array of taps forms a series of resistive changes whereby a change of resistance from one tap of the array of taps to an adjacent tap of the array of taps comprises a known increment of the series of resistive changes, the series of resistive changes being configured to adjust a setting of the control circuit.

2. The potentiometer assembly of claim 1, the wiper further comprising:
a primary wiper body, the primary wiper body being electrically conductive;
a first leg member being coupled to and extending downwardly from the primary wiper body, the first leg member being electrically conductive;
a second leg member being coupled to and extending downwardly from the primary wiper body, the second leg member being electrically conductive; and
a secondary wiper body being electrically isolated from the primary wiper body, the secondary wiper body being electrically conductive.

3. The potentiometer assembly of claim 2, the wiper further comprising:
a third leg member being coupled to and extending downwardly from the secondary wiper body, the third leg member being electrically conductive; and
a coupler physically attaching the primary wiper body to the secondary wiper body such that the primary wiper body and the secondary wiper body move together along the top surface of the substrate, the coupler comprising an electrically insulative material whereby the third leg member remains electrically isolated from the first leg member and the second leg member when the primary wiper body is attached to the secondary wiper body.

4. The potentiometer assembly of claim 1, wherein the known increment of the series of resistive changes is linear when the array of taps are spaced equidistantly from each other, and wherein the known increment of the series of resistive changes is non-linear when the array of taps are spaced at variable distances from each other.

5. The potentiometer assembly of claim 1, further comprising a power trace being coupled to the top surface of the substrate, the power trace being electrically conductive wherein the power trace is configured to indicate a power state of the control system, the wiper contacting and moving across the power trace.

6. The potentiometer assembly of claim 5, the power trace further comprising:
an off-state member being configured to indicate an off-power state when the wiper contacts the off-state member;
an on-state member being spaced from the off-state member, the on-state member being configured to indicate an on-power state when the wiper contacts the on-state member; and
a gap being positioned between the off-state member and the on-state member, the gap being configured to indicate a neutral power state when the wiper is positioned on the gap.

7. The potentiometer assembly of claim 1, further comprising a flexible material covering the common trace and the array of copper taps, the flexible material being positioned between the wiper and the substrate wherein the flexible material is configured to inhibit contaminants from contacting the common trace and the array of copper taps, the flexible material being conductive wherein the wiper exerts a pressure downwardly on the flexible material as the wiper moves along the top surface of the substrate whereby the flexible material contacts the common trace and at least one of the array of taps to electrically connect the common trace to the array of taps.

8. The potentiometer assembly of claim 1, wherein the substrate has a rectangular shape whereby the wiper has a linear motion across the substrate.

9. The potentiometer assembly of claim 1, wherein the substrate has a circular shape whereby the wiper has a rotational motion across the substrate.

10. A potentiometer assembly comprising:
a substrate having a top surface, the top surface being electrically insulative, the substrate comprising a printed circuit board, the substrate being configured for installation within a control circuit having a control switch;
a wiper being movably coupled to the top surface of the substrate, the wiper being configured to be operably coupled to the control switch wherein the wiper is configured to move along the top surface of the substrate in response to the control switch of the control circuit being actuated, the wiper comprising:
a primary wiper body, the primary wiper body being electrically conductive;
a first leg member being coupled to and extending downwardly from the primary wiper body, the first leg member being electrically conductive;
a second leg member being coupled to and extending downwardly from the primary wiper body, the second leg member being electrically conductive;
a secondary wiper body being electrically isolated from the primary wiper body, the secondary wiper body being electrically conductive;
a third leg member being coupled to and extending downwardly from the secondary wiper body, the third leg member being electrically conductive;
a coupler physically attaching the primary wiper body to the secondary wiper body such that the primary wiper body and the secondary wiper body move together along the top surface of the substrate, the coupler comprising an electrically insulative material whereby the third leg member remains electrically isolated from the first leg member and the second leg member when the primary wiper body is attached to the secondary wiper body;
a resistive material being coupled to the top surface of the substrate, the resistive material being electrically resistive;
a common trace being coupled to the top surface of the substrate, the common trace being spaced from the resistive material, the second leg member of the wiper contacting and moving along the common trace when the wiper moves along the substrate, the common trace being electrically conductive;
an array of taps being coupled to the top surface of the substrate, the array of taps being electrically conductive, the array of taps being electrically coupled to the resistive material, the array of taps physically contacting and extending perpendicularly outward from the resistive material toward the common trace wherein the first leg member of the wiper contacts at least one of the array of taps while being spaced from the resistive material and wherein the wiper moves across the array of taps when the wiper moves along the substrate, the first leg member of the wiper contacting at least one of the array of taps, the array of taps being spaced from each other along a length of the resistive material wherein the array of taps forms a series of resistive changes whereby a change of resistance from one tap of the array of taps to an adjacent tap of the array of taps comprises a known increment of the series of resistive changes, the series of resistive changes being configured to adjust a setting of the control circuit;
wherein the known increment of the series of resistive changes is linear when the array of taps are spaced equidistantly from each other;
wherein the known increment of the series of resistive changes is non-linear when the array of taps are spaced at variable distances from each other;
a power trace being coupled to the top surface of the substrate, the power trace being electrically conductive wherein the power trace is configured to indicate a power state of the control circuit, the third leg member of the wiper contacting the power trace when the wiper moves along the top surface of the substrate, the power trace further comprising:
an off-state member being configured to indicate an off-power state when the third leg member of the wiper contacts the off-state member, the off-state member comprising copper;
an on-state member being spaced from the off-state member, the on-state member being configured to indicate an on-power state when the third leg member of the wiper contacts the on-state member, the on-state member having a length being the same as a length of the top surface of the substrate over which the array of taps is positioned, the on-state member comprising copper;
a gap being positioned between the off-state member and the on-state member, the wiper contacting the top surface of the substrate when the third leg member is positioned on the gap, the gap being configured to indicate a neutral power state when the third leg member is positioned on the gap; and
a flexible material covering the common trace, the array of copper taps, and the power trace, the flexible material being positioned between the wiper and the top surface of the substrate wherein the flexible material is configured to inhibit contaminants from contacting the common trace, the array of copper taps, and the power trace, the flexible material being conductive wherein the wiper exerts a pressure downwardly on the flexible material as the wiper moves along the top surface of the substrate whereby the flexible material contacts the common trace, at least one of the array of taps, and the power trace to electrically connect the common trace to the array of taps and the power trace.

11. The potentiometer assembly of claim 10, wherein the substrate has a rectangular shape whereby the wiper has a linear motion across the top surface of the substrate.

12. The potentiometer assembly of claim 10, wherein the substrate has a circular shape whereby the wiper has a rotational motion across the top surface of the substrate.
